(19) United States
(12) Patent Application Publication
(10) Pub. No.: US 2011/0003184 A1
(43) Pub. Date: Jan. 6, 2011

(54) BATTERY HAVING CLOSING PLUG

(76) Inventor: Thomas Koch, Northeim (DE)

Correspondence Address: Oliver Intellectual Property LLC, P.O. Box 1670, Cotuit, MA, 02635, US

(21) Appl. No.: 12/918,318

(22) PCT Filed: Dec. 17, 2008
(86) PCT No.: PCT/EP2008/010769

§ 371 Date: Aug. 18, 2010

(30) Foreign Application Priority Data
Feb. 19, 2008 (DE) 10 2008 009 864.7

(51) Int. Cl. H01M 2/00

(52) U.S. Cl. 429/53

(57) ABSTRACT

A rechargeable battery, particularly a lead storage battery, having filling openings that are disposed in the battery cover and lead to the battery cells, closing plugs being provided in said filling openings in a sealing manner, wherein, between the inner wall of the filling opening and the outer wall of the stopper, at least one sealing lip is present, which can be deformed by overpressure in the battery cell, in order to relieve the overpressure.

### CROSS-REFERENCE

This application is a section 371 of PCT/08/10769, filed 17 Dec. 2008, which claims priority from German application DE 10 2008 009 864.7 filed 19 Feb. 2008.

### FIELD OF THE INVENTION

The invention relates to a rechargeable battery, especially a lead storage battery formed with filling openings, arranged in the battery cover sheet, leading to the battery cells, into which openings closing plugs or stoppers are sealingly inserted.

### BACKGROUND

In many lead storage batteries, for purposes of sealing the filling openings in the cover, plugs or stoppers of various constructions are used. These stoppers are secured by screwing in, by engagement, etc. and generally include a seal with respect to the battery cover. In the case of batteries with fixed electrolyte, a valve is often integrated into the inner structure of the stopper, so that no oxygen from outside gets into the cells and thereby runs them down prematurely. The supplemental provision of a valve in the stopper requires a high manufacturing investment.

### SUMMARY OF THE INVENTION

An object of the invention is to improve a battery, of the aforementioned kind, in such a way that, with minimal manufacturing investment, a reliable pressure equalization is obtained.

This object is achieved, in accordance with the invention, in that, between the inner wall of the filling opening and the outer wall of the stopper, an elastic, especially an annular, sealing lip, which is deformable by an overpressure in the battery cell, is provided, in order to release outward the overpressure.

Upon installation in conventional lead-acid batteries, the sealing lip creates a further safety aspect, since no destructive overpressure can occur anymore in the battery.

Upon installation in batteries with fixed electrolyte, integrating the valving functionality into the injection-molding process results in substantially lowered manufacturing investment. Further, the count of necessary individual parts is minimized.

Advantageous refinements of the invention are set forth in the detailed description below.

### BRIEF FIGURE DESCRIPTION

An exemplary embodiment of the invention is illustrated in the drawings and described in greater detail below. Shown are:

FIG. 1, a vertical axial section through a battery filling opening with stopper;

FIG. 2, an enlarged detail from FIG. 1, with the sealing lip in a sealing configuration; and

FIG. 3, the enlarged detail with the sealing lip opened by the internal pressure.

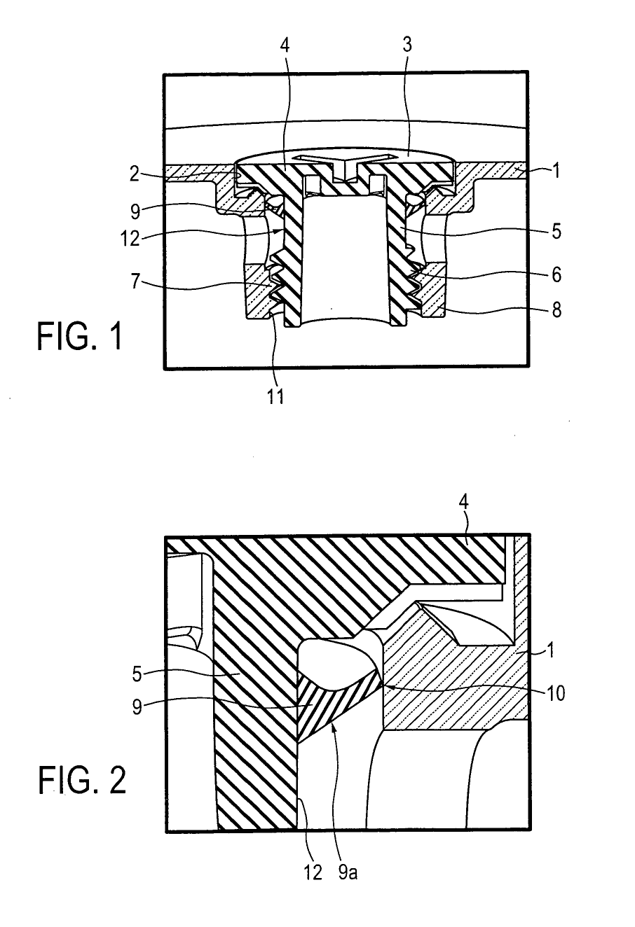

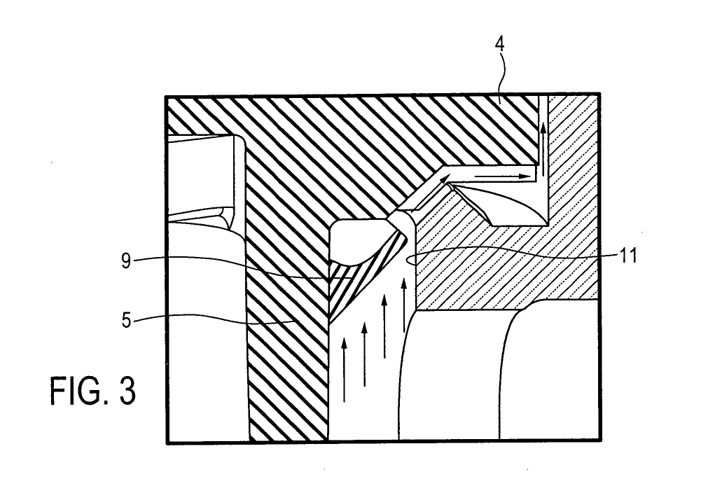

### DETAILED DESCRIPTION

A rechargeable battery has a block-type case (not shown) which holds the current-storing components and, on its upper side, is closed off by a battery cover 1. In plastic cover 1 are formed filling openings, into which plastic sealing stoppers are mounted.

Each sealing stopper 3 has an upper horizontal closure plate or flange 4 which, when the stopper is inserted, does not project out over the battery cover 1. On the underside of plate or flange 4, there is formed a tubular part 5, whose axis stands vertically and has an external thread 6, with which the stopper 3 can be screwed into an internal thread 7 in a tubular region of the filling opening 2.

Above the external thread 6, on the outer surface of the tubular part 5, there is coaxially secured an elastic, preferably annular, sealing lip 9 which, in its non-loaded configuration, sealing engages, with its annular outer rim 10, against the inner wall 11 of the filling opening 2. The underside of sealing lip 9 forms a slanted surface 9a, which tends to resist the internal pressure.

Thus, instead of a seal or gasket on the closing stopper, a specially formed, preferably annular, sealing lip 9 is employed, which simultaneously fulfills the function of a valve. This is either assembled or, advantageously, directly injection-molded by a 2-component method. The valving functionality is achieved, after assembly of the stopper into the respective filling opening, by pretensioning against the wall of the cover opening. Upon increase of the internal pressure in the sealed vessel by a predetermined amount, the pressure-generating medium can, by temporary deformation of the sealing lip, get past this sealing lip, until the pressure no longer suffices to maintain the deformation.

According to an alternative (not shown), the annular sealing lip 9 is secured, not on the closing stopper, but rather on the inner wall 11 of the filling opening 2, preferably made by a 2-component injection process, so that the outer rim 10 of the sealing lip engages against the outer wall 12 of the tubular part 5 of the closing stopper. According to this embodiment also, the sealing lip 9 is temporarily opened by the internal pressure.

In order to assure reliable valving functionality, the material has a greater elasticity than the material of the closing stopper 3 and/or that of the battery cover 1.

What is claimed is:

1. A rechargeable battery having, in filling openings (2) of the battery cover (1), respective stoppers (3) sealingly engaged, characterized in that,
between an inner wall (11) of the filling opening (2) and an outer wall (12) of the stopper (3), at least one sealing lip (9) engages, which is deformable by an overpressure in the battery cell, in order to relieve the overpressure.

2. A battery according to claim 1, characterized in that
the sealing lip (9) is secured on one of the outer wall (12) of the stopper (3) and the inner wall (11) of the filling opening (2).

3. A battery according to claim 1, characterized in that
the underside of the sealing lip (9) forms a slanted surface (9a) which abuts against the cell internal pressure.

4. A battery according to claim 1, characterized in that
the material of the sealing lip (9) has a greater elasticity than the material of the stopper (3) and the material of the battery cover (1).

5. A method of making a closing plug with a flexible annular sealing lip spanning a space between an interior sidewall of a battery filling opening and an outer sidewall of said closing plug located therein, comprising the steps of
injecting, into a mold, a material having a first modulus of elasticity, to form said closing plug;
injecting, into said mold, a material having a second, higher, modulus of elasticity, to form said flexible annular sealing lip; and
permitting the resulting plug to cure, prior to removal from said mold.

6. A method of making a battery cover (3) with a flexible annular sealing lip spanning a space between an interior sidewall of a battery filling opening formed in said cover and an outer sidewall of a closing plug located therein, comprising the steps of
injecting, into a mold, a material having a first modulus of elasticity, to form said cover (3);
injecting, into said mold, a material having a second, higher, modulus of elasticity, to form said flexible annular sealing lip (9); and
permitting the resulting cover to cure, prior to removal from said mold.

7. A battery according to claim 2, characterized in that
the underside of the sealing lip (9) forms a slanted surface (9a) which abuts against the cell internal pressure.

8. A battery according to claim 2, characterized in that
the material of the sealing lip (9) has a greater elasticity than the material of the stopper (3) and than the material of the battery cover (1).
